(19) United States
(12) Patent Application Publication
(10) Pub. No.: US 2005/0183483 A1
(43) Pub. Date: Aug. 25, 2005

(54) Composting of organic waste

(76) Inventor: Harvey Ambrose, Oshawa (CA)

Correspondence Address: BIRCH STEWART KOLASCH & BIRCH, PO BOX 747, FALLS CHURCH, VA, 22040-0747, US

(21) Appl. No.: 11/065,479

(22) Filed: Feb. 25, 2005

(30) Foreign Application Priority Data
Feb. 25, 2004 (CA) 2,458,703

(51) Int. Cl. C05F 11/08

(52) U.S. Cl. 71/6

(57) ABSTRACT

The process of the subject invention may be carried out by means of two or more vessels. The vessels are arranged in succession such that the outlet of one vessel is located above the inlet of the next vessel in succession. At the bottom of each vessel is a moving floor which causes the organic material to move from the feed end to the discharge end of the vessel. Organic waste is fed into the first vessel and moves through each vessel in turn. As it moves from one vessel to the next it falls and as it does so it mixes and aerates. The process of the invention may also be carried out in a closed vessel having a number of compartments disposed end to end. Organic waste enters the upstream compartment, travels downstream through each of said compartments in turn and discharges from said downstream compartment. The waste is agitated at the outlet of each compartment while being impelled into the next compartment in succession

### FIELD OF THE INVENTION

This invention relates to the composting of organic waste and more particularly to a method of treating large volumes of organic material composed of table scraps and other food organic waste, leaves, scrap paper, weeds and other vegetation in order to cause the organic material to degrade into compost which does not harm the environment and which may be useful as a fertilizer, a soil supplement and a variety of other useful substances.

### BACKGROUND OF THE INVENTION

Composting is a well researched and well understood process. Until recently however it has not been widely used as a means of disposing of organic waste because other methods were more economical. The most economical method until recently was land-filling. However because of the escalating cost of land in the vicinity of urban centres, the risk of pollution of the land by the organic waste and the increasing opposition to land-filling by adjacent landowners, land-filing is less and less viable as a means of disposing of organic waste.

### SUMMARY OF THE INVENTION

According to the subject invention, a method of composting a large volume of organic waste is described in order to convert the material into a solid product which has a variety of different commercial uses. The method obviates the costs of land-filling since the product is in demand and may be disposed of by selling it rather than by land-filling it.

Not only is the solid end product of value but so too is the biogas that is generated as composting takes place. Those gases can be used as a fuel or to generate energy.

The process of the subject invention is carried out in various ways, One way involves the use of two or more vessels. Preferably three vessels are used. The vessels are relatively large and are arranged in succession such that the outlet of one vessel is located above the inlet of the next vessel in succession. At the bottom of each vessel is a moving floor which causes the organic material to move from the feed end to the discharge end of the vessel. The method of the subject invention involves the steps of feeding the organic waste to the inlet of the first vessel. The organic waste is caused to move to the discharge end of the first vessel where it falls into the feed end of the next vessel in succession. From the discharge end of the next vessel the organic waste falls to the third vessel and so on. In most cases, the organic waste which discharges from the last vessel in succession is composted to the point where it is suitable for such uses such as a fertilizer, a soil supplement, a berm, a sound-barrier. It may also be safely disposed of at a land-fill site.

Another way of carrying out the method of the invention involves the use of a closed vessel having a plurality of compartments each having an inlet and an outlet and being arranged such that organic waste enters the upstream compartment, travels downstream through each of said compartments in turn and discharges from said downstream compartment. The steps of this method include causing the organic waste to advance downstream from the inlet to the outlet of each compartment; and agitating the organic waste at the outlet of each compartment while impelling the agitated organic waste into the next compartment in succession

### DESCRIPTION OF THE DRAWINGS

The method of the subject invention is described with reference to the accompanying drawings in which:

FIG. 1 is a simplified elevation of the composting vessels for use according to the first method for carrying out the invention;

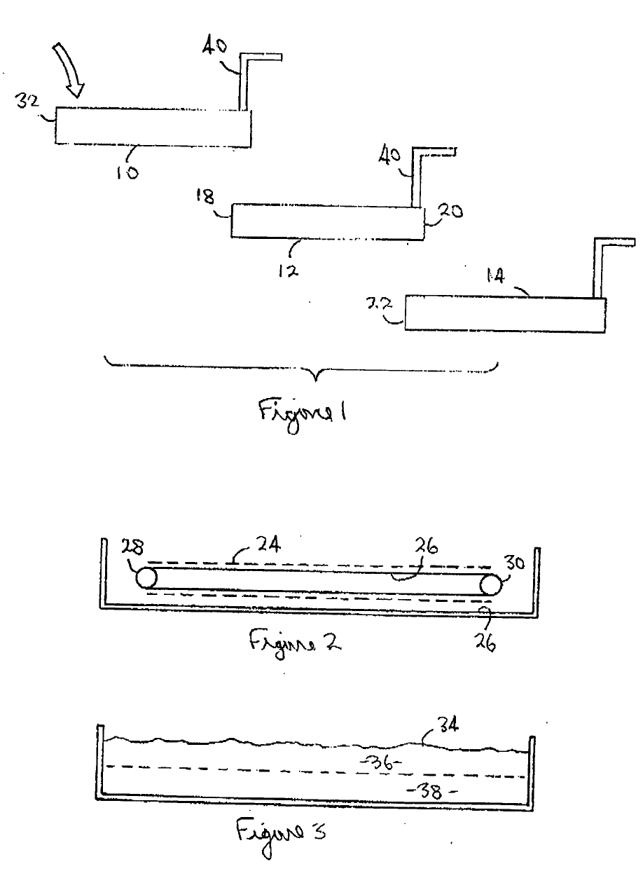

FIG. 2 is a simplified elevation of the moving floor at the bottom of each vessel:

FIG. 3 is an elevation of a vessel containing a layer of organic waste;

FIG. 4 is a perspective view of a composting vessel for use according to a second method for carrying out the invention;

FIG. 5 is a perspective view of a pair of impellers for moving the organic waste through the vessel of FIG. 4;

FIGS. 6 to 11 are elevations of the interior of the vessel of FIG. 4 showing the way in which the organic waste moves in the vessel; and

FIGS. 12 to 15 show the way in which a moving floor moves the organic waste through the vessels.

Like reference characters refer to like parts throughout the description of the drawings.

With reference to the drawings, three composting vessels 10, 12 and 14 are arranged in a row. The outlet 16 of the first vessel 10 is spaced above the inlet 18 of the next vessel 12 in succession and similarly, the outlet 20 of the second vessel is spaced above the inlet 22 of the third vessel 14.

Preferably the vessels are relatively large, typically about 14 metres long, 2.5 metres wide and 2.5 metres high and are composed of aluminum to minimize corrosion. The vessels are closed except at the inlet end which is open to allow organic waste to enter the vessel and at the outlet end which is also open to allow the compost at that point to discharge from the vessel.

From the outlet end of all but the last vessel, the composting material falls into the feed end of the next vessel in succession. The outlet of each vessel is about 4.5 to 5 metres vertically above the inlet of the next vessel in succession.

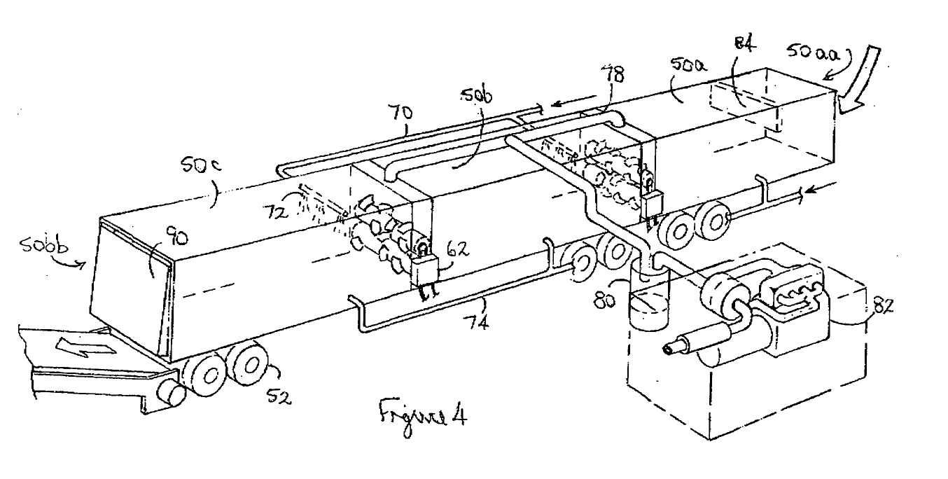

With reference to FIG. 2, spaced above the floor 26 of each vessel is a moving floor composed of a number of slats 24 mounted to a belt 26. The belt passes around a pair of drams 28, 30 mounted in bearings for rotation at the upstream and downstream ends of the floor. The moving floor serves to move the feed from the inlet end of each vessel to the outlet end.

The starting material is composed of organic material generated and collected or separated in households, restaurants, hospitals and other institutions where food is prepared or consumed. Such material is commonly referred to as table scraps. The starting material can also be other food waste, scrap paper, weeds and other vegetation. Typically it will be organic waste that is generated in households and is separated by occupants of the households from other waste such as paper, cardboard, glass and plastic bottles, non-organic waste and so on. Typically, such organic waste is picked up by municipalities and is transported to a central collection point. Accordingly, it is contemplated that municipalities will be the largest supplier or source of the starting material of the invention

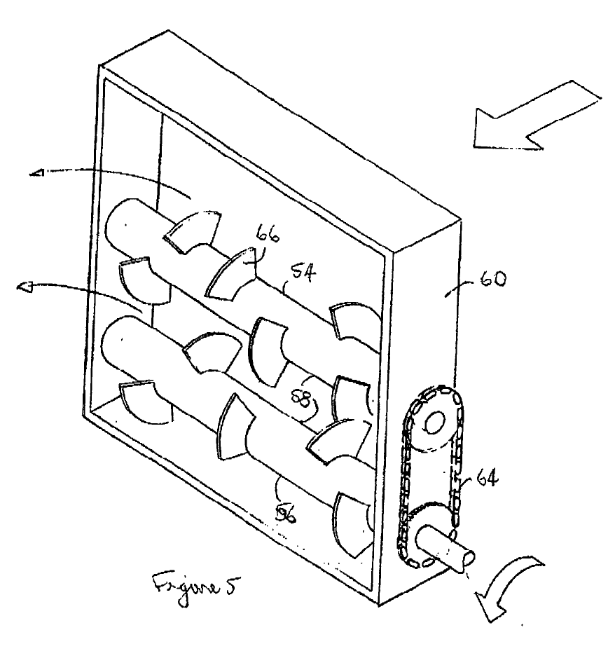

The operation of the process is described with reference to FIGS. 2 and 3. The starting material is fed into the inlet 32 of vessel 10. The organic material once fed into the first vessel falls onto the moving floor and begins to move downstream toward the discharge end of the vessel. Preferably the floor moves at a rate that will cause the organic waste to move from the inlet end of the first vessel to the outlet end in about 24 hours. At the outlet, the organic waste discharges from that vessel and falls into the next vessel in succession. In the next vessel and in all subsequent vessels, the floor moves at the same rate so that the organic material remains in each vessel for about 24 hours.

The quantity of organic waste fed to the first vessel is such that when the organic waste reaches the outlet of that vessel, it is in a pile 34 of sufficient thickness that the layer 36 at the top of the pile falls onto the inlet of the second vessel before the layer 38 beneath layer 36 falls. In that way, mixing and aeration of the organic waste occurs as the organic waste enters the second vessel, in like manner, mixing of the organic waste occurs as it enters each vessel in succession.

Water vapour and biogas, principally methane, are generated in catch vessel as composting progresses. These gases discharge through outlet 40 in each vessel and the biogas is separated by conventional means and is collected and used for the production of heat or as a supplemental fuel in conjunction with a hydrogen fuel cell. The gases can be also be used as fuel for a generator to produce relatively low cost electricity.

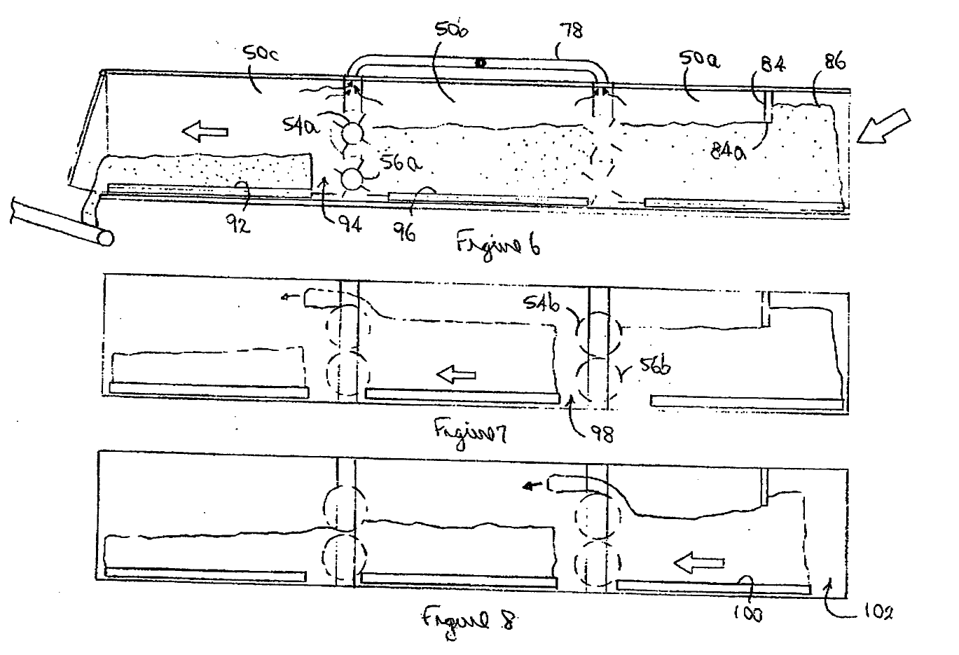

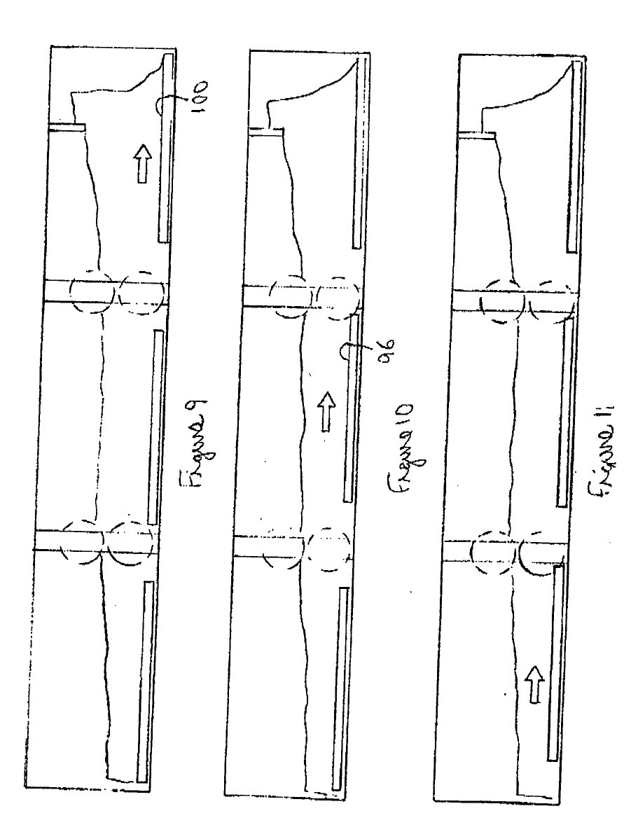

With reference to FIGS. 4 and 5, the composting vessel, generally 50, is made up of three interconnected trailers. Each trailer defines a separate compartment in the vessel, the first trailer defines an upstream compartment 50a, the second trailer defines an intermediate compartment 50b and the third trailer defines a downstream compartment 50c. The trailers are mounted on wheels 52 so that once the trailers have been separated from each other, the vessel is portable should it be desirable to move the vessel from one location to another.

The trailers are placed end to end and their forward and rear walls are removed so that there is a clear passage for composting material through all three trailers from one end of the vessel to the other. At the junction of each pair of trailers there is a pair of vertically spaced laterally extending impellers 54, 56. Each impeller has a horizontal shaft 58 which is mounted in bearings in a rectangular frame 60 which is fastened to the walls, ceiling and floor of the trailers. The lower shaft in each pair of impellers is driven by an electric motor 62 and the lower shaft is connected to the upper shaft by means of chain link 64.

Each shaft has a number of radially extending blades 66 which are arranged to lift the compost and to fling it downstream into the next trailer in succession.

Water may be required for composting and water pipes 70 are provided for supplying that water to the vessel. The water is discharged through sprinklers 72 near the upper wall of the vessel. Air optionally supplemented by a stream of oxygen flows through pipes 74 and discharges from openings in the pipe near the floor of the vessel.

Gases generated during composting collect above the solid and liquid compost and pipes 78 are provided for carrying those gases first to a condenser 80 where water vapour in the gases condenses and collects and may be chemically decomposed by electrolysis.

The biogas from the condenser flows to the air inlet of a conventional turbine 82. The turbine causes a pressure drop in the gases fed into it and that pressure drop is the driving force for the flow of biogas through pipes 78. The turbine supplies electricity to power the impellers, the moving floor and other electrically powered components of the vessel. Hydrogen from electrolysis of the water in condenser 80 may be used to supplement or enrich the fuel consumed by the turbine.

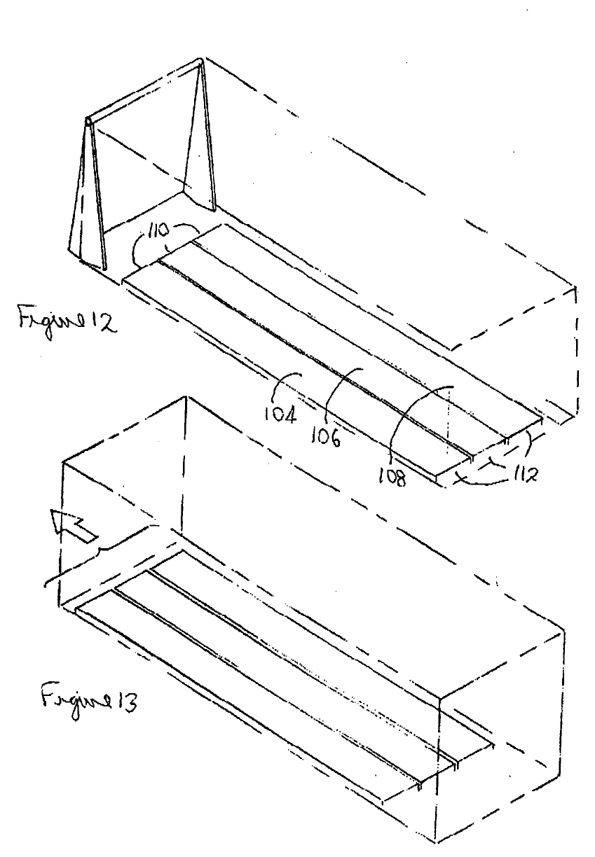

To minimize the amount of gases which escape from the intake or upstream end 50aa of the vessel, a baffle plate 84 is provided. With reference to FIGS. 4 and 6, the baffle plate is attached to the ceiling of the vessel in the vicinity of the intake but downstream of it. The plate extends downwardly to the desirable level of compost in the vessel. Sufficient starting material is then fed into the intake of the vessel to exceed that level so that baffle and die starting material cooperate to prevent gases within the vessel from escaping through the intake. FIG. 6 shows the lower edge 84a of the baffle plate as being below the level 86 of starting material at the intake. There is no space between the baffle and compost piled up against it and accordingly gases within the vessel cannot escape to the atmosphere through the inlet.

At the discharge end 50bb of the vessel a swinging door 90 is provided which is hinged to the ceiling of the vessel. The door is of sufficient weight that gravity will cause it to remain closed. It will only open when it is lifted upward and that will only happen when compost is discharging from the vessel. The door accordingly acts to minimize the escape of gases from the discharge end.

The way in which the organic waste moves through the vessel is described with reference to FIGS. 6 to 11. With reference first to FIG. 6, the organic waste in the downstream compartment 50c is first advanced toward the discharge end of the compartment by means of the moving floor 92 described below. The waste advances in increments through the compartment. Typically, each incremental advance is about 25 cm. As the waste advances there is a gap 94 at the upstream end of the pile of waste in that trailer. Impellers 54a, 56a are then activated to elevate the waste at the downstream end of intermediate compartment 50b and propel it into the downstream compartment as illustrated in FIG. 7. As the waste is being impelled in this manner it is being mixed and aerated. At the same time the moving floor 96 in the intermediate compartment is activated to carry the waste in that compartment downstream, again in increments of about 25 cm. As the waste moves forward, a gap 98 forms on the floor in the upstream end of the pile of compost in that compartment. Next, impellers 54b, 56b are activated as is the moving floor 100 in the upstream compartment 50a as illustrated in FIG. 8. A gap 102 forms at the point of entry of the waste into the upstream compartment.

In FIG. 9, the moving floor 100 in the upstream compartment retracts or withdraws to the inlet of that compartment. The compost however remains stationary because of the way in which the floor operates, as is explained below. In FIG. 10, the moving floor 96 in the intermediate compartment retracts and again the compost in that compartment does not move and finally, the floor in the downstream compartment retracts without causing the compost to move. While the moving floor in the compartments retracts the impellers remain stationary.

When all three floors have retracted, the floor begins to advance once again in stages in the manner described above starting with the floor in the downstream compartment as illustrated in FIG. 6.

The moving floor used to move the waste through the compartment of the vessel is commonly known as a “Keith Walking Floor” and operates in a way that is well known. A short description of its operation may however be useful to an understanding of how the moving floor causes the waste to advance but not to retract.

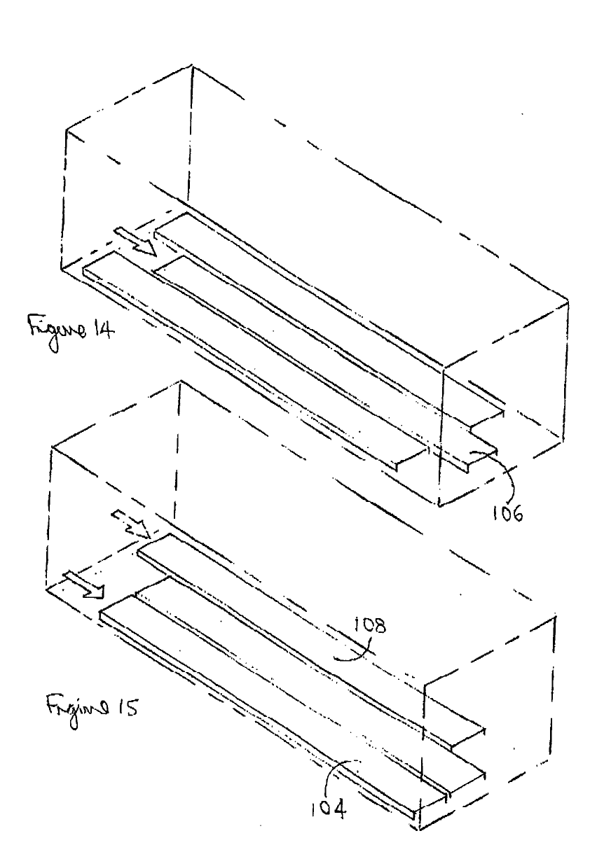

With reference to FIGS. 12 to 15, the floor is made up of three panels 104, 106 and 108 which are disposed side by side and which slide independently of each other. In FIG. 12 the panels are in their retracted position where their forward and rear ends 110, 112 respectively are aligned with each other. In FIG. 13 the three panels advance toward the swinging door 90 at the downstream end of the vessel by means of three hydraulic activators (not illustrated). One actuator activates each panel. The panels move together as a unit and the forward and rear ends remain aligned as they advance. When they move together, they will carry the compost which lies on them forward,.

In FIG. 14, die central panel 106 retracts but the two other panels remain stationary. When the central panel is fully retracted, outer panel 104 retracts as illustrated in FIG. 15. Finally, when panel 104 is fully retracted, the third panel 108 retracts. When the panels move in this way, the compost will remain stationary.

Composting generally occurs in two stages. Initially the reaction is characterized by high temperatures, high consumption of oxygen, rapid biodegradation of organic solids and emission of significant odour. As the reaction progresses, the biological activity slows and the temperature declines. Curing also occurs at this stage. When the final product reaches the required level of stability, the process is complete.

The level of stability of the final product, i.e. its degree of inertness will depend on a number of factors. There may be a legal requirement that must be complied with before use of the final product is permitted as, for example, a fertilizer, a soil supplement and so on. As well, commercial considerations also wilt dictate an acceptable level op stability in the end product. For example, a relatively stable end product may not be acceptable where the product is being used in the vicinity of urban areas whereas it is acceptable when it is being used in the county.

Complete stability is not readily attainable and in general is not desirable since an end product which is completely stable i.e. inert, would not be suitable as a soil supplement or a fertilizer.

In order to ensure that the level of stability of the end product reduces significantly, the organic waste within each vessel should have the following properties:
1. Its temperature, at least in the initial stages of composting, should be within the range of about 55 to 60 degrees Celsius.

2. Its level of oxygen should be maintained above 10 percent by volume and preferably in the range of about 12 to 18 percent.

3. Its moisture level should be about 50 percent by weight.

4. Its carbon to nitrogen ration should be about 1:22.

5. Its pH should be within the range of about 6.5 to 7.

Considering each of these properties in turn:

Temperature

The initial temperature of the composting material quickly reaches a thermophilic temperature due to the highly exothermic nature of the biological reaction. Eventually as biological activity diminishes the temperature returns to ambient levels during curing.

It is preferable for the composting mass to attain an optimum temperature of between 55 and 60 degrees C. for some time to cause bacterial growth and an inactivation of pathogens. At temperatures in excess of 60 degrees, biological activity may be inhibited and at temperatures approaching 80 degrees C., all activity ceases.

While temperatures may inherently reach the desirable range without the necessity of an external source of heat, the temperature may drop below this range if there is a deficiency of oxygen, a low moisture level, a thermal kill of micro-organisms or a toxic effect due to contaminants in the material.

Pathogenic organisms are present in various organic materials and are a potential threat to the operators of any composting system and to users of compost. Pathogens belong to four main groups: bacteria, viruses, parasites and fingi. In composting, heat is the primary factor in killing or inactivating pathogens. Thermophilic temperatures must be reached and maintained for an adequate time to kill or inactivate pathogens effectively.

Oxygen

Aeration maintains aerobic conditions for the micro-organisms and inhibits the formation of anoxic or anaerobic conditions and resultant noxious odours. Determination of the quantity of oxygen requirements is dependent on both biological and physical variables. Different wastes will exhibit different oxygen demands. Aeration rates are therefore specific to the chemical and physical character of the organic waste to be composed.

Moisture Level

The micro-organisms require an aqueous or moist environment to effectively biodegrade organic wastes. Moisture content, temperature and aeration are closely related. As moisture evaporates, the reaction slows, the temperature drops below the required level and the process is inhibited. Subsequent addition of moisture will increase the reaction rate to previous levels and the process will continue.

C/N Ratio

Control of the carbon to nitrogen ratio is important in optimizing the biological decomposition. The micro-organisms consume carbon as a source of energy and both carbon and nitrogen are used to build cell structure. The C/N ratio declines as the decomposition process proceeds. The composting reaction is inhibited at C/N ratios greater than 25:1 due to lack of nitrogen. If a compost having a high C/N ratio is added to soil, micro-organisms in the soil compete with crops for available nitrogen thereby reducing growth. At C/N ratios lower than 20:1, the energy source (carbon) is less than is needed for conversion of nitrogen into proteins. Such material added to soil would result in the soil microbes removing the excess nitrogen as ammonia thereby denying it to plants.

pH

The optimum pH range for composting is 5.5 to 8.5. Typically pH levels drop when composting begins, then gradually rise as the reaction progresses.

General

In some cases the organic waste in the vessels will inherently have the properties enumerated above as the process of decomposition or degradation takes place and in such cases there is no necessity to take active steps to ensure that the organic waste has such properties. However it may be necessary to make adjustments when, for example, the organic waste has a low moisture content, a highly acidic or alkaline composition, a relatively high C/N ratio and so on. The way in which these adjustments can be made is within the knowledge of organic chemists or technicians.

It is desirable that the final product of the process be composted uniformly throughout the material. The product should be free of pockets of non-composted or partially composted material. In order to achieve uniform composting, the material should be thoroughly aerated and mixed as it passes from one vessel to the next of the process.

If the final product is not uniformly composted, the material can be further aerated to improve its quality. To do so, air under pressure can be introduced into the bottom of each vessel and into the path of the material as if falls from one vessel to the next. The final product can also be improved by taking steps to ensure that the material is mixed more thoroughly as it passes from vessel to vessel. The steps to do so are described above including adjusting the length of the fall of the material from one vessel to the next, adjusting the speed of the impellers, adjusting the rate of material fed to the first vessel and the rate of passage through the compartment and vessels and so on.

It will be understood, of course, that modifications can be made in the processes of the invention described herein without departing from the scope and purview of the invention.

1. A method of composting organic waste within a plurality of vessels each having an inlet and an outlet, said vessels being arranged in a row such that the outlet of one said vessel is spaced above the inlet of the next said vessel in succession, said method comprising the steps of:
(i) feeding the organic waste to the inlet of the first said vessel in succession;
(ii) causing the organic waste to advance from the inlet to the outlet of said first vessel;
(iii) causing the organic waste at the outlet of said first vessel to fall to the inlet of the next said vessel in succession;
(iv) causing the organic waste at the outlet of each said vessel subsequent to the first said vessel in succession to fall to the inlet of the next said vessel in succession;
(v) causing the fallen organic waste to advance from the inlet to the outlet of each subsequent said vessel; and
(vi) discharging the fallen organic waste from the outlet of the last said vessel in succession.

2. The method of claim 1 further including adjusting the rate of feed of organic waste to the inlet according to step (i) such that when said organic waste reaches the outlet of said first vessel, it is in a pile of sufficient thickness that the portion of said organic waste at the top of the pile falls onto the inlet of the second vessel before the portion of organic waste vertically beneath the former said portion falls.

3. The method of claim 1 including closing each said vessel to the atmosphere except for the inlet and outlet thereof.

4. The method of clam 3 further including collecting gas generated in each said vessel and combusting said gas thus collected for the production of heat or power

5. The method of claim 1 farther including adjusting the temperature within each said vessel to within the range of about 55 to 60 degrees Celsius.

6. The method of claim 1 further including adjusting the level of moisture of the organic waste within each said vessel to about 50 percent by weight.

7. The method of claim 1 further including adjusting the pH of the organic waste within each said vessel to within the range of about 6.5 to 7.

8. The method of claim 1 further including adjusting the ratio of carbon to nitrogen in the organic waste within each said vessel to about 1:22.

9. A method of composting organic waste within a closed vessel having a plurality of compartments each having an inlet and an outlet and being arranged such that organic waste enters said upstream compartment, travels downstream through each of said compartments in turn and discharges from said downstream compartment, said method comprising the steps of:
(i) causing the organic waste to advance downstream from the inlet to the outlet of each said compartment; and
(ii) agitating the organic waste at the outlet of each said compartment while impelling the agitated organic waste into the next said compartment in succession.

10. A method of composting organic waste with or a closed vessel having upstream, intermediate and downstream compartments each having an inlet and an outlet and being arranged such that said waste enter said upstream compartment, travels downstream through each of said compartments in turn and discharges from said downstream compartment, said method including the following steps in succession:
(i) feeding the organic waste into the inlet of said upstream compartment;
(ii) causing the organic waste in said downstream compartment to travel downstream an increment and collecting any organic waste which discharges from said downstream compartment;
(iii) causing the organic waste in said intermediate compartment to travel downstream an increment while agitating any organic waste at the outlet of said intermediate compartment and while impelling said the organic waste so agitated into said downstream compartment; and
(iv) causing the organic waste in said upstream compartment to travel downstream an increment while agitating any organic waste at the outlet of said upstream compartment and which impelling said the organic waste so agitated into said intermediate compartment.

11. The method of claim 10 further including the steps of;
(v) providing a baffle plate which extends downwardly into said upstream compartment; and
(vi) feeding sufficient organic waste into in inlet of said upstream compartment according to stop (i) to reach said plate and to prevent any gases within said vessel from escaping through the latter said inlet.

12. The method of claim 11 including the step of:
(vii) providing means for preventing any gases within said vessel from escaping through the latter said outlet at the outlet of said downstream compartment except at the time that organic waste is discharging from said downstream compartment.

13. The method of claim 10 including the step of evacuating any gases within said vessel and causing said evacuated gases to flow to the air inlet of a turbine.

14. The method of claim 10 further including collecting gas generated in each said compartment and combusting said gas thus collected for the production of heat or power.

15. The method of claim 10 further including adjusting the temperature within each vessel to within the range of about 55 to 60 degrees Celsius.

16. The method of claim 10 further including adjusting the level of moisture of the organic waste within said vessel to about 50 percent by weight.

17. The method of claim 10 further including adjusting the pH of the organic waste within said vessel to within the range of about 6.5 to 7.

18. The method of claim 10 further including adjusting the ratio of carbon to nitrogen in the organic waste within said vessel to about 1:22
